(19) United States
(12) Patent Application Publication
(10) Pub. No.: US 2013/0200814 A1
(43) Pub. Date: Aug. 8, 2013

(54) LED LIGHTING APPARATUS AND DIMMING METHOD THEREOF

(71) Applicants: CHUN-KUANG CHEN, Taipei City (TW); MENG CHAI WU, Hsinchu County (TW); PO-SHEN CHEN, New Taipei City (TW); FENG-LING LIN, Pingtung County (TW); HUI YING CHEN, Changhua County (TW)

(72) Inventors: CHUN-KUANG CHEN, Taipei City (TW); MENG CHAI WU, Hsinchu County (TW); PO-SHEN CHEN, New Taipei City (TW); FENG-LING LIN, Pingtung County (TW); HUI YING CHEN, Changhua County (TW)

(73) Assignee: LEXTAR ELECTRONICS CORP., HSINCHU (TW)

(21) Appl. No.: 13/561,699

(22) Filed: Jul. 30, 2012

(30) Foreign Application Priority Data
Feb. 8, 2012 (TW) 101104030

(51) Int. Cl. H05B 37/02

(52) U.S. Cl. 315/210

(57) ABSTRACT

An LED lighting apparatus and a dimming method thereof are disclosed. The LED lighting apparatus is coupled to a power source through a power switch. The method includes providing a first lighting unit and a second lighting unit; detecting whether or not the power switch has been turned on; and gradually adjusting a light mixing ratio between the first lighting unit and the second lighting unit according to a turn-on duration of the power switch and storing a color temperature value, accordingly.

### BACKGROUND OF THE INVENTION

1. Field of the Invention

The present invention relates to a lighting apparatus; in particular, to a dimmable lighting circuit and a lighting apparatus having the same.

2. Description of Related Art

Because of the progression of human living culture, the lighting devices have become indispensable appliances in daily life. Conventionally, the lighting devices are usually incandescent lamps (tungsten lamps). Thus, if the lighting device needs to be dimed, only need to dispose an extra variable resistor turning knob between the electrical plug and the lamp, and the user may change the brightness by adjusting the variable resistor. However, the incandescent lamps have the disadvantages of heating, short lifetime, low efficiency, and large power consumption.

As the light emitting diode (LED) has the advantages including high lighting efficiency, long lifetime, hard to be damaged, low power consumption, environment friendly, and small in size, it is broadly used in many fields, such as traffic lights, streetlamps, torch lamps, backlights of liquid crystal displays, or all types of LED lamps. The LED is a solid state luminous element comprising of P type and N type semiconductor materials, and can generate self-radiating lights within the spectrums of ultraviolet light, visible lights, and infrared lights.

Common LED lighting apparatuses include LED lamps and LED light tubes. The LED light tubes may be used for replacing the conventional fluorescent tubes, and may be arranged on the conventional lamp holder. The LED light tubes have a circuit board and several LED components. The LED components are driven by direct current power source, and the brightness thereof is relative to the current flowing through the LED. Generally, the brightness of LED increases as the current increases.

However, the biggest defect of the conventional lighting device is that they are not adjustable and cannot be dimed. Since the conventional lights are mainly turned on and off by the switch located on the wall, as shown in FIG. 1A and FIG. 1B. FIG. 1A shows a schematic diagram illustrating a conventional light switch, and FIG. 1B, shows a circuit diagram of a conventional lamp. Since the color temperature and the brightness of the conventional lamps are fixed from the procurement, consequently the function of the switch is only for full brightness or full darkness control.

### SUMMARY OF THE INVENTION

The present invention discloses an LED lighting apparatus which utilizes the conventional switches on the wall for configuring the color temperature.

The present invention discloses an LED lighting apparatus which utilizes the conventional switches on the wall for configuring the brightness.

For achieving the aforementioned objectives and others, the present invention provides an LED lighting apparatus which is coupled to a power source through a power switch. The LED lighting apparatus includes a first lighting unit, a second lighting unit, a driving unit, and a detection unit. The first lighting unit has at least one first LED, and the second lighting unit has at least one second LED. The driving unit is coupled to the first lighting unit and the second lighting unit. The driving unit is for driving the first and the second lighting units. The detection unit is coupled to the driving unit and the power switch, for detecting a status of the power switch. When the power switch is turned on, the detection unit gradually adjusts a light mixing ratio between the first and second lighting units according to a turn-on duration of the power switch and stores a color temperature value, accordingly.

For achieving aforementioned objectives and others, the present invention provides another LED lighting apparatus coupled to a power source through a power switch. The LED lighting apparatus includes a lighting unit, a driving unit, and a detection unit. The lighting unit has at least one LED. The driving unit is coupled to the lighting unit and for driving the lighting unit. The detection unit is coupled to the driving unit and the power switch. The detection unit is used for detecting a status of the power switch. When the power switch is turned on, the detection unit gradually adjusts a current flowing through the lighting unit according to a turn on duration of the power switch and stores a brightness value, accordingly.

For achieving the aforementioned objectives and others, the present invention further provides a dimming method for an LED lighting apparatus. The LED lighting apparatus is coupled to a power source through a power switch. The method includes providing a first lighting unit and the second lighting unit; detecting whether or not the power switch has been turned on; and when the power switch is turned on, gradually adjusting a light mixing ratio between the first and second lighting units according to a turn-on duration of the power switch and storing a color temperature value, accordingly.

According to a preferred exemplary embodiment of the present invention, when the power switch is turned off within a predetermined time interval after being turned on, the detection unit stores the color temperature value, and adjusts the light mixing ratio between the first and second lighting units according to the color temperature value to have the LED lighting apparatus generate corresponding color temperature.

According to a preferred exemplary embodiment of the present invention, the detection unit adjusts the light mixing ratio between the first and second lighting units by configuring a duty cycle of a first pulse width modulation signal corresponds to the first lighting unit and a duty cycle of a second pulse width modulation signal corresponds to the second lighting unit.

According to an preferred exemplary embodiment of the present invention, after the detection unit stores the color temperature value, it may redetects whether or not the power switch has been turned on, gradually adjusts the currents flowing through the first and the second lighting units according to turn-on duration of the power switch and stores a brightness value, accordingly. In addition, when the detection unit detects that the power switch has been switched for four times within a reset time interval, the detection unit then stored color temperature value and brightness value.

The spirit of the present invention is in increase the control means by modify the driving circuit inside the LED lighting apparatus while accommodate the conventional switches, thereby enabling the user to configure and adjust the color temperature and brightness accordingly. The user does not have to install an extra dimming circuit, and thus no modification is need to the house for the installment of the dimming circuit.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1A shows a schematic diagram of a conventional light switch;

FIG. 1B shows a circuit diagram of a conventional lamp;

FIG. 2 shows a circuit block diagram of an LED lighting apparatus according to a first exemplary embodiment of the present invention;

FIG. 3A shows a switch timing diagram of a power switch 205 of the LED lighting apparatus according to the first exemplary embodiment of the present invention;

FIG. 3B shows a driving waveform and timing diagram of the LED lighting apparatus according to the first exemplary embodiment of the present invention;

FIG. 3C shows a switch timing diagram of resetting the power switch 205 in the LED lighting apparatus according to the first exemplary embodiment of the present invention;

FIG. 4 shows a relatively detail circuit block diagram of an LED lighting apparatus according to a second exemplary embodiment of the present invention;

FIG. 5A shows a driving waveform and timing diagram illustrating the initial state of the LED lighting apparatus according to the second exemplary embodiment of the present invention;

FIG. 5B shows a driving waveform and timing diagram illustrating the LED lighting apparatus having the light mixing ratio being 50% according to the second exemplary embodiment of the present invention;

FIG. 5C shows a driving waveform and timing diagram illustrating the LED lighting apparatus at end of time t1 according to the second exemplary embodiment of the present invention;

FIG. 5D shows a resetting waveform and timing diagram of the LED lighting apparatus according to the second exemplary embodiment of the present invention;

FIG. 6 shows a circuit block diagram of the LED lighting apparatus according to the first exemplary embodiment of the present invention;

FIG. 7A shows a switch timing diagram of configuring a power switch 604 of an LED lighting apparatus according to a third exemplary embodiment of the present invention;

FIG. 7B shows a driving waveform and timing diagram of the LED lighting apparatus according to the third exemplary embodiment of the present invention;

FIG. 8 shows a relatively detail circuit block diagram of an LED lighting apparatus according to a fourth exemplary embodiment of the present invention;

FIG. 9A shows a driving waveform and timing diagram illustrating the initial state of the LED lighting apparatus according to the fourth exemplary embodiment of the present invention;

FIG. 9B shows a driving waveform and timing diagram of the LED lighting apparatus having the pulse width being 50% according to the fourth exemplary embodiment of the present invention;

FIG. 9C shows a driving waveform and timing diagram illustrating the LED lighting apparatus at end of time t1 according to the fourth exemplary embodiment of the present invention;

FIG. 10 shows a flow chart of a dimming method for an LED lighting apparatus according to a sixth exemplary embodiment of the present invention; and

FIG. 11 shows a flow chart of resetting steps associated with the dimming method for the LED lighting apparatus according to the sixth exemplary embodiment of the present invention.

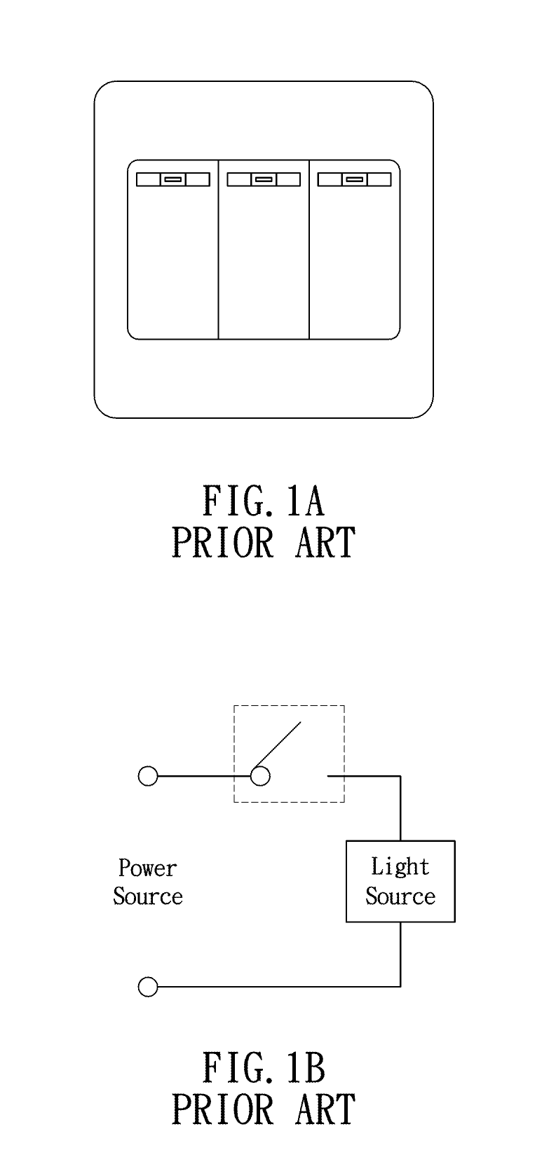

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

### First Exemplary Embodiment

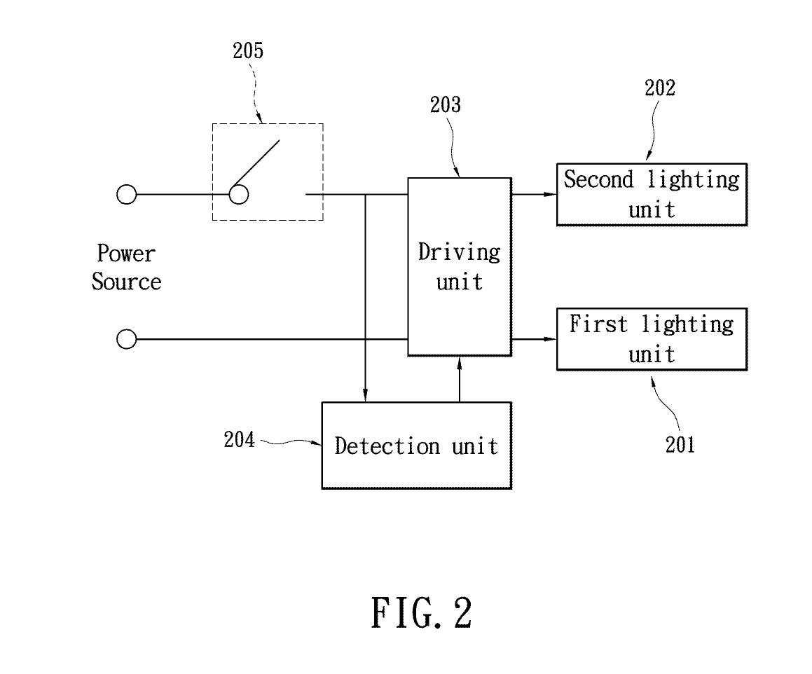

FIG. 2 shows a circuit diagram of an LED lighting apparatus according to a first exemplary embodiment of the present invention. Please refer to FIG. 2, the LED lighting apparatus includes a first lighting unit 201, a second lighting unit 202, a driving unit 203, and a detection unit 204. For describing the spirit of the present invention, a power switch 205 is shown in the circuit, to represent the typical light switch on the wall in common users' houses. The first lighting unit 201 and the second lighting unit 202 are both implemented by the LEDs. The differences are that the first lighting unit 201 and the second lighting unit 202 use the lighting units emitting different color temperatures. For example, the first lighting unit 201 emits 6000K color temperature (cold color temperature), and the second lighting unit 202 emits 2900K color temperature (warm color temperature).

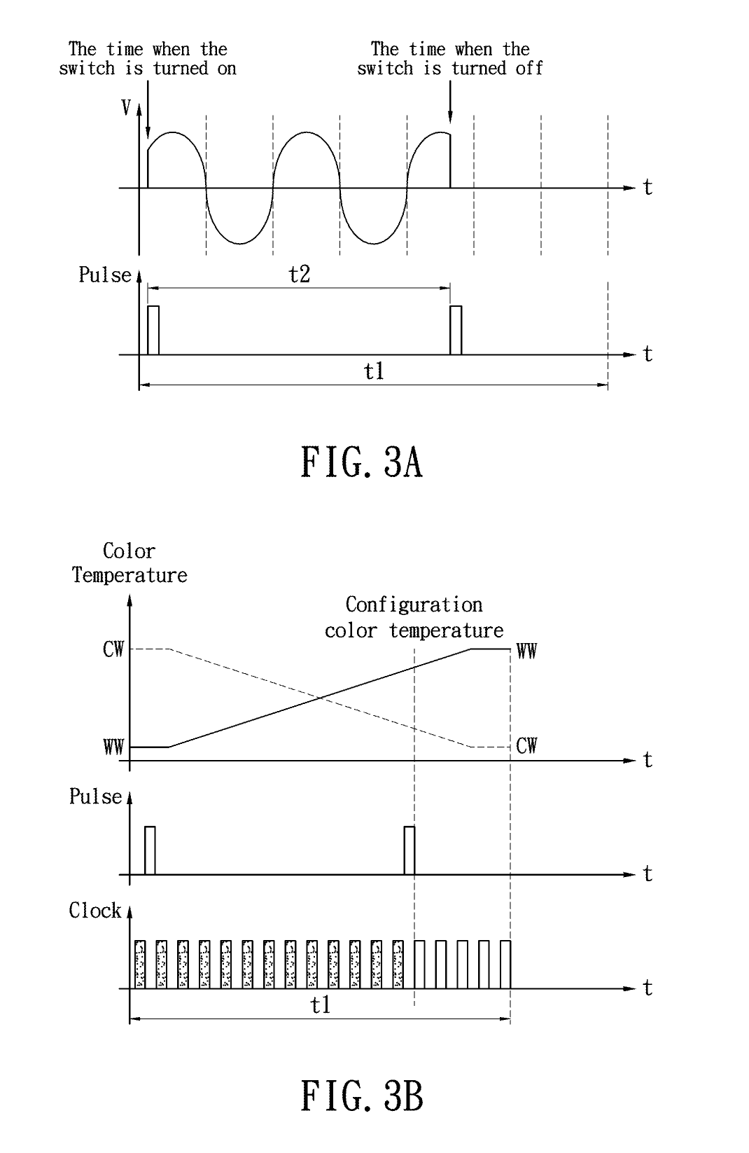

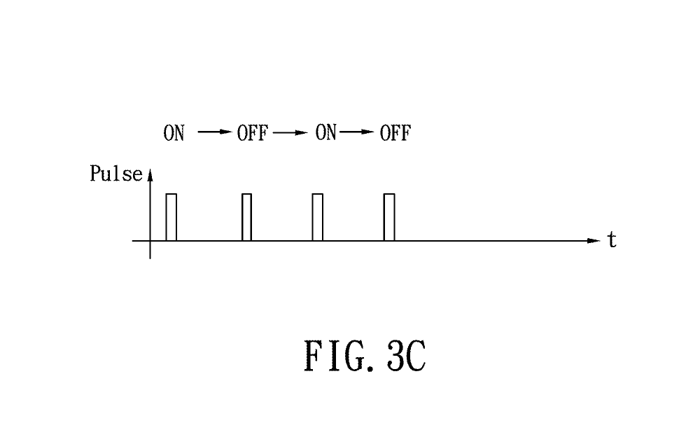

The detection unit 204 is used for detecting the status of the power switch 205. When the detection unit 204 detects that the power switch 205 is turned on by the user, the detection unit 204 then controls the driving unit 203 so as to have the driving unit 203 begin to drive the first lighting unit 201 and the second lighting unit 202. It's worth noting that the driving unit 203 drives the first lighting unit 201 and the second lighting unit 202 gradually. FIG. 3A shows a switch timing diagram of the power switch 205 of the LED lighting apparatus according to the first exemplary embodiment of the present invention. FIG. 3B shows a driving waveform and timing diagram of the LED lighting apparatus according to the first exemplary embodiment of the present invention. Please refer to FIG. 2, FIG. 3A, and FIG. 3B concurrently. For example, at the beginning, the driving unit 203 may adjust the first lighting unit 201 of cold color temperature CW to the brightest level, and adjusts the second lighting unit 202 of warm color temperature WW to the darkest level. After that, along with the increasing of the time t2 that the power switch 205 has been turned on, the first lighting unit 201 of the cold color temperature CW may be gradually darkened, and the second lighting unit 202 of the warm color temperature WW may be gradually brightened.

When the user considers that the present color temperature is the one he or she desired, the user may switch the power switch 205 again. When the detection unit 204 detects that the power switch 205 has been turned off by the user, the detection unit 204 may record a light mixing ratio between the first lighting unit 201 and the second lighting unit 202 (ex. the color temperatures) before the power switch 205 is turned off. When next time the user turns on the power switch 205, the driving unit 203 may directly use the recorded light mixing ratio between the first lighting unit 201 and the second lighting unit 202 to drive the first lighting unit 201 and the second lighting unit 202.

If the user has not conduct any switching to the power switch 205 after a predetermined time t1, the detection unit 204 then uses the configurations of the lowest cold color temperature CW and the highest warm color temperature WW to drive the lighting units, accordingly.

FIG. 3C shows a switch timing diagram of resetting the power switch 205 in the LED lighting apparatus according to the first exemplary embodiment of the present invention. When the user considers that the present color temperature are inappropriate, the user may reset the LED lighting apparatus by operating the power switch 205, to erase previous configurations. For example, the user switches the power switch 205 for four times (ON→OFF→ON→OFF) within a predetermined time interval. When the detection unit 204 detects that the power switch 205 been switched for four consecutive times (ON→OFF→ON→OFF) within the predetermined time interval, the detection unit 205 may erase the previously stored light mixing ratio between the first lighting unit 201 and the second lighting unit 202.

### Second Exemplary Embodiment

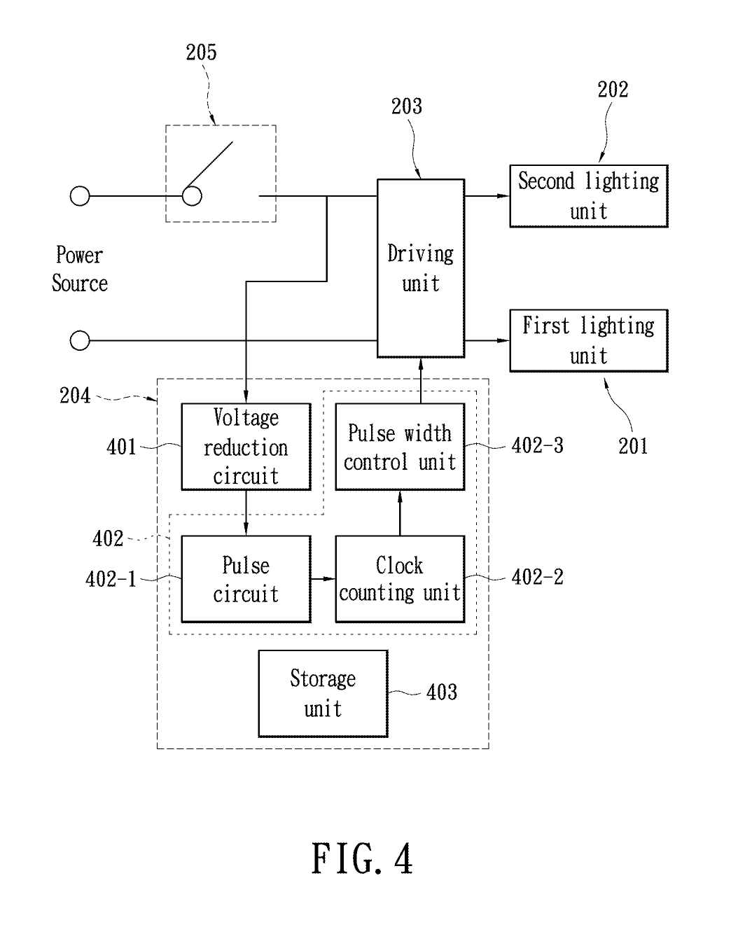

FIG. 4 shows a relatively detail circuit diagram of an LED lighting apparatus according to a second exemplary embodiment of the present invention. Please refer to FIG. 4, the LED lighting apparatus has the same part as in the first embodiment by having a first lighting unit 201, a second lighting unit 202, a driving unit 203, a detection unit 204, and a power switch 205. The differences are that the detection unit 204 in this exemplary embodiment includes a voltage reduction circuit 401, a control unit 402, and a storage unit 403, wherein the control unit 402 further has a pulse circuit 402-1, a clock counting unit 402-2, and a pulse width control unit 402-3. The voltage reduction circuit 401 is coupled to the power source through the power switch 205. The control unit 402 is coupled to the voltage reduction circuit 401 and the driving unit 203. The control unit 402 counts the time that the power switch 205 has been turned on according to the output voltage of the voltage reduction circuit 401, and outputs a color temperature control signal to the driving unit 203 according to the color temperature value. Specifically, the pulse circuit 402-1 is coupled to the voltage reduction circuit 401 and is used for generating pulse signals corresponding to the output voltage variation of the voltage reduction circuit 401. The clock counting unit 402-2 is coupled to the pulse circuit 402-1 and is used for counting the time that the power switch has been turned on according to the pulse signals outputted by the pulse circuit 402-1. The pulse width control unit 402-3 is coupled to the clock counting unit 402-2 and is used for outputting the color temperature control signals to the driving unit 203 according to the turn-on duration of the power switch 205.

Similar to the first exemplary embodiment, in the second exemplary embodiment, when the user needs to adjust the color temperature, he or she may first turn on the power switch 205. Subsequently, the clock counting unit 402-2 of the control unit 402 is used for counting the time that the power switch 205 is turned on according to the pulse signals outputted by the pulse circuit 402-1. The pulse width control unit 402-3 outputs the color temperature control signals to the driving unit 203 according to the turn-on duration of the power switch 205. In general, the color temperature control signals is used for controlling the light mixing ratio between the first lighting unit 201 and the second lighting unit 202. The primary method is to control the brightness associated with the first lighting unit 201 and the second lighting unit 202. The first lighting unit 201 and the second lighting unit 202 respectively use LEDs to emit lights. The LEDs are in practice are controlled by configuring the pulse widths of the pulse width modulation (PWM) signals. Consequently, the color temperature control signals are divided into the pulse width modulation signals PWM1 of the first lighting unit 201, and the pulse width modulation signals PWM2 of the second lighting unit 202.

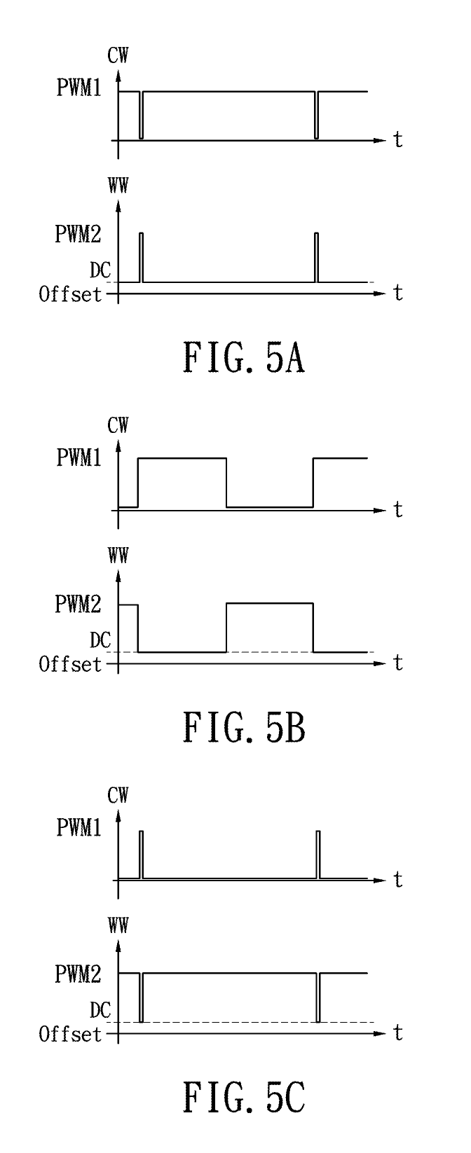

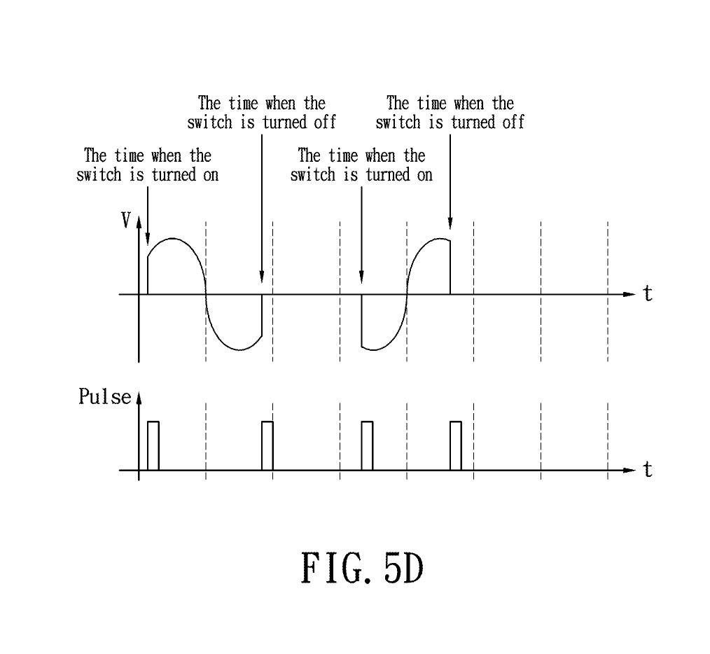

FIG. 5A shows a driving waveform and clock diagram illustrating the initial state of the LED lighting apparatus according to the second exemplary embodiment of the present invention. FIG. 5B shows a driving waveform and clock diagram illustrating the LED lighting apparatus having the light mixing ratio being 50% according to the second exemplary embodiment of the present invention. FIG. 5C shows a driving waveform and clock diagram illustrating the LED lighting apparatus at end of time t1 according to the second exemplary embodiment of the present invention. Please refer to FIG. 4, FIG. 5A, 5B, and FIG. 5C concurrently. When color temperature adjustment starts, the pulse width modulation signals PMW1 of the first lighting unit 201 may be set to be the widest and the pulse width modulation signals PWM2 of the second lighting unit 202 may be set to be the narrowest, as shown in FIG. 5A.

Along with the increasing of counting value of the clock counting unit 402-2, the pulse width modulation signals PWM1 of the first lighting unit 201 may be narrowed, and the pulse width modulation signals PMW2 of the second lighting unit 202 may be widened. When the user determines that the present color temperature is the one he or she desired, the user may turn off the power switch 205. At the moment, the clock counting unit 402-2 may stop counting the time, while the storage unit 403 may store the present color temperature adjustment information, such as the pulse width sizes of the pulse width modulation signals PWM1 associated with the first lighting unit 201 and the pulse width modulation signals PWM2 of the second lighting unit 202, respectively, or the counting value of the clock counting unit 402-2. As long as the information may be converted into the pulse widths information for the pulse width modulation signals PWM1 of the first lighting unit 201 and the pulse width modulation signals PWM2 of the second lighting unit 202, or be converted into the information of light mixing ratio between the first lighting unit 201 and the second lighting unit 202, it can serve as the color temperature information and stored in the storage unit 403. Thus, the scope of the present invention is not restricted thereby.

Please refer to FIG. 5A, FIG. 5B, and FIG. 5C carefully. We can figure out that all of the pulse width modulation signals PWM2 in FIG. 5A, 5B, and FIG. 5C have a DC offset. In the field of LED, the brightness may also be adjusted by changing the DC offset of the pulse width modulation signals instead of changing the pulse widths thereof. Thus, the brightness adjustment and the color temperature adjustment may be implemented by the means of changing the DC offset of the pulse width modulation signals, and the details description are omitted.

FIG. 5D shows a reset waveform and clock diagram of the LED lighting apparatus according to the second exemplary embodiment of the present invention. Please refer to FIG. 5D, when the user considers that the present color temperature is inappropriate, he or she may reset the LED lighting apparatus by operating the power switch 205. Specifically, the user may switch the power switch 205 for four times (ON→OFF→ON→OFF) within a predetermined time interval. When the detection unit 204 successively detects four consecutive switching operations of the power switch 205 within the predetermined time (such as the four pulses in FIG. 5D) interval, the detection unit 204 may erase the light mixing ratio between the first lighting unit 201 and the second lighting unit 202 stored in the storage unit 403. Thus, next time when the power switch 205 is turned on, the user may reconfigure the light mixing ratio.

### Third Exemplary Embodiment

Similarly, although the aforementioned embodiments only explains method and the circuits for adjusting the color temperature, however, the described method and circuits may also be applied in the application of brightness adjustment. The following description in the third exemplary embodiment describes how the present invention adjusts brightness.

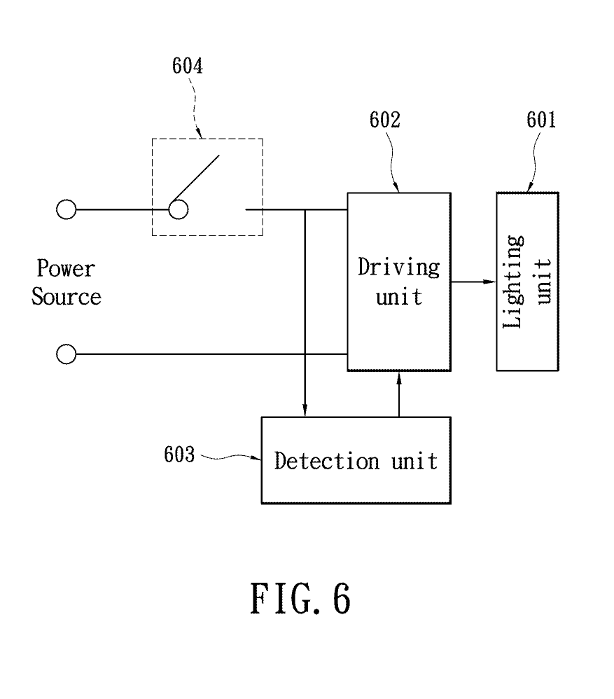

FIG. 6 shows a circuit block diagram of the LED lighting apparatus according to the third exemplary embodiment of the present invention. Please refer to FIG. 6. The LED lighting apparatus includes a lighting unit 601, a driving unit 602, and a detection unit 603. To explain the spirit of the present invention, the aforementioned circuits further has a power switch 604 representing the lamp switch on the wall in the house of a typical user. The lighting unit 601 is implemented by using LED.

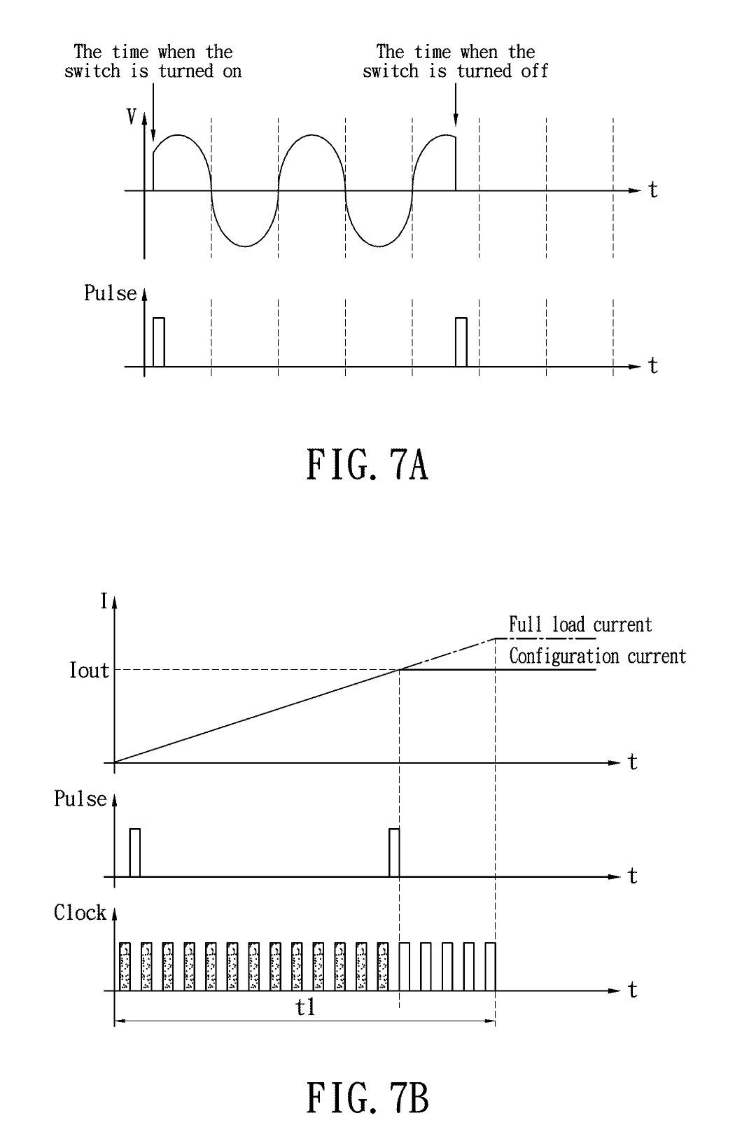

The detection unit 603 is used for detecting the status of the power switch 604. When the detection unit 603 detects that the power switch 604 has been turned on by the user, it may control the driving unit 602, to have the driving unit 602 driving the lighting unit 601. It is worth noting that the driving unit 602 drives the lighting unit 301 gradually. FIG. 7A shows a switching clock diagram of configuring the power switch 604 of the LED lighting apparatus according to the third exemplary embodiment of the present invention. FIG. 7B shows a driving waveform and clock diagram of the LED lighting apparatus according to the third exemplary embodiment of the present invention. Please refer to FIG. 6, FIG. 7A, and FIG. 7B at the same time. For example, at the beginning, the driving unit 602 may adjust the lighting unit 601 to the darkest level. After that, the lighting unit 601 may be gradually lightened, or equivalently, the current outputted to the lighting unit 601 is gradually increased.

When the user considers that the present brightness is appropriate, he or she may switch the power switch 604 again. When the detection unit 603 detects that the power switch 604 is turned off, it may record the brightness of the lighting unit 601 before the power switch 604 is turned off. When next time the user turns on the power switch 604, the driving unit 602 may drive the lighting unit 601 according to the recorded brightness.

Similarly, when the user considers that the present brightness is inappropriate, he or she may reset the LED lighting apparatus by operating the power switch 604, such as switching the power switch 604 for four times (ON→OFF→ON→OFF) within a predetermined time interval. When the detection unit 603 detects that the power switch 604 has been switched for four consecutive times (ON→OFF→ON→OFF) within the predetermined time interval, it may erase the recorded brightness of the lighting unit 601.

### Fourth Exemplary Embodiment

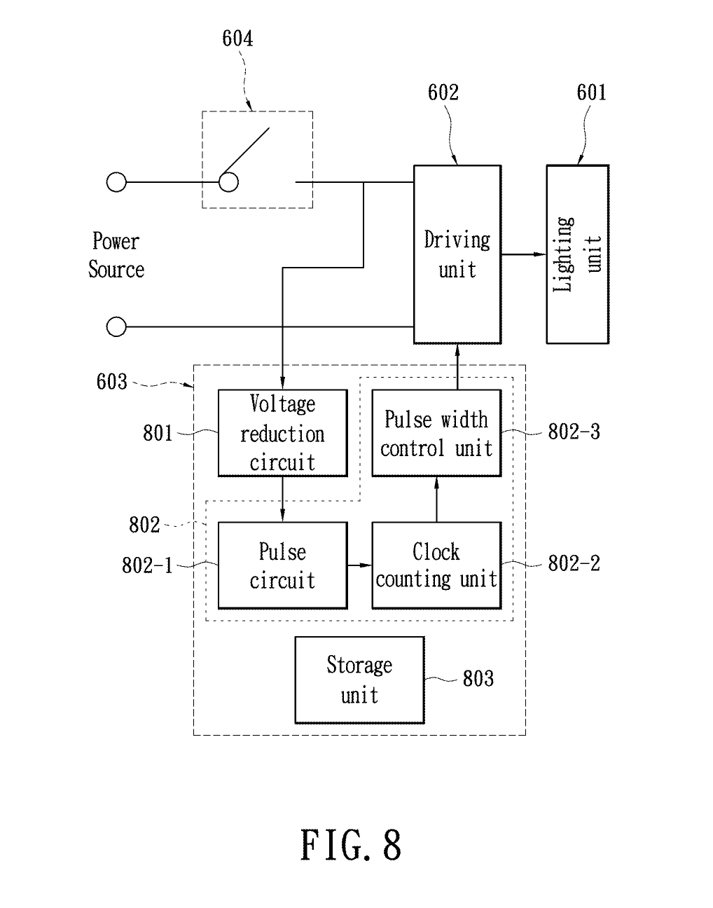

FIG. 8 shows a circuit block diagram of the LED lighting apparatus according to the fourth exemplary embodiment of the present invention. Please refer to FIG. 8, the similar part between the LED lighting apparatus and the aforementioned first exemplary embodiment is that the LED lighting apparatus having a lighting unit 601, a driving unit 602, a detection unit 603, and a power switch 604. The differences are that the detail circuits of the detection unit 603 include a voltage reduction circuit 801, a control unit 802, and a storage unit 803. The control unit 802 further includes a pulse circuit 802-1, a clock counting unit 802-2, and a pulse width control unit 802-3. The voltage reduction circuit 801 is coupled to the power source through the power switch 604. The control unit 802 is coupled to the voltage reduction circuit 801 and the driving unit 602. The control unit 802 is used for counting the time that the power switch 604 has been turned on according to the output voltage of the voltage reduction circuit 801, and outputs a brightness control signal to the driving unit 602 according to the brightness value. Specifically, the pulse circuit 802-1 is coupled to the voltage reduction circuit 801 and is used for generating corresponding pulse signals according to the changes of the output voltages of the voltage reduction circuit 801. The clock counting unit 802-2 is coupled to the pulse circuit 802-1 and is used for counting the time that the power switch 604 is turned on according to the pulse signals outputted by the pulse circuit 802-1. The pulse width control unit 802-3 is coupled to the clock counting unit 802-2 and is used for outputting the brightness control signals to the driving unit 602 according to the turn-on duration of the power switch 604.

The fourth exemplary embodiment is similar to the third exemplary embodiment. When the user needs to adjust the brightness, he or she may turn on the power switch 604 first. After that, the clock counting unit 802-2 of the control unit 802 may count the time that the power switch 604 is turned on according to the pulse signals which is outputted by the pulse circuit 802-1. According to the counted time, the pulse width control unit 802-3 may output the brightness control signals to the driving unit 602. In general, the brightness control signals are primarily used for controlling the brightness of the lighting unit 601. Moreover, the lighting unit 601 uses LEDs as light emitting components. Since in practice the LEDs are controlled by configuring the pulse widths of the pulse width modulation (PWM) signals. Thus, the brightness control signals may serve as the pulse width modulation signals PWM.

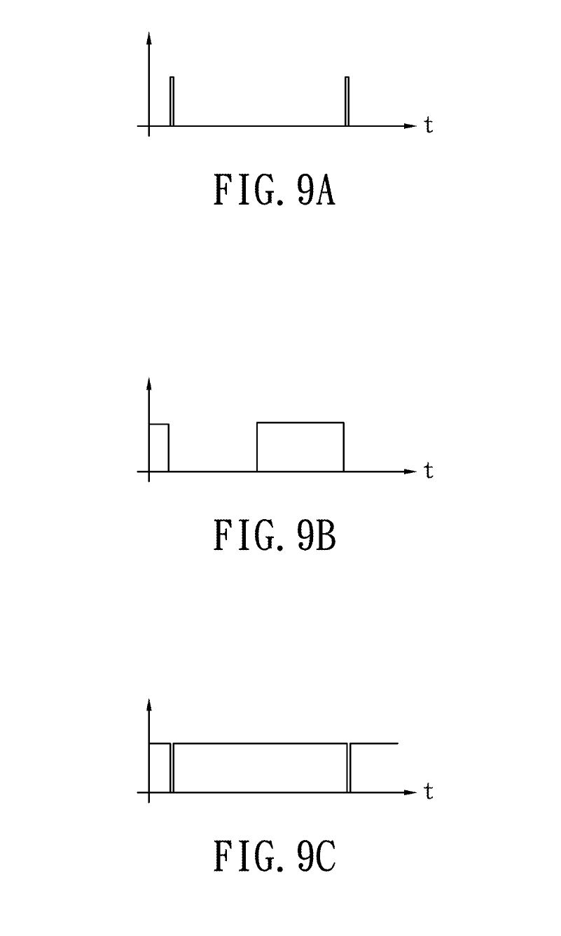

FIG. 9A shows a driving waveform and timing diagram illustrating the initial state of the LED lighting apparatus according to the fourth exemplary embodiment of the present invention. FIG. 9B shows a driving waveform and timing diagram of the LED lighting apparatus having the pulse width being 50% according to the fourth exemplary embodiment of the present invention. FIG. 9C shows a driving waveform and timing diagram illustrating the LED lighting apparatus at end of time t1 according to the fourth exemplary embodiment of the present invention. Please refer to FIG. 8, FIG. 9A, FIG. 9B, and FIG. 9C concurrently. When begins the brightness adjustments, the pulse width modulation signals PWM of the lighting unit 601 may be set to the narrowest. Along with increasing in the counting value of the clock counting unit 802-2, the pulse width modulation signals PWM of the lighting unit 601 may be widened. When the user considers that the present brightness is appropriate, he or she may turn off the power switch 604. At the moment, the clock counting unit 802-2 may stop counting, and the storage unit 803 may store the present color temperature adjustment information, such as the pulse width size of the pulse width modulation signals PWM of the lighting unit 601, or the counted value of the clock counting unit 802-2. As long as the information which can be converted into the pulse width information of the pulse width modulation signals PWM associated with the lighting unit 601 or the brightness information of the lighting unit 601, the information may serve as the color temperature information stored in the storage unit 803. Thus, the scope of the present invention is not limited thereby.

### Fifth Exemplary Embodiment

After referring to the aforementioned embodiments, those who are skilled in the art may know that the present invention may adjust the color temperature and the brightness at the same time by using the circuits in FIG. 2. For example, when the power switch is switched by the first- and second-time (ON-1→t1→OFF-2), the color temperature may be adjusted by using the method described in the first exemplary embodiment. After the adjustment of the color temperature, when the power switch is switched by the third- and fourth-time (ON-3→t1→OFF-4), the brightness of the first lighting unit and the second lighting unit may be adjust simultaneously according to the ratio of color temperature configured in the last time using the method described in the third exemplary embodiment.

Similarly, when the user is not satisfied with the above mentioned configurations, he or she may reset the configurations by successively switching the power switch for four times (ON→OFF→ON→OFF).

### Sixth Exemplary Embodiment

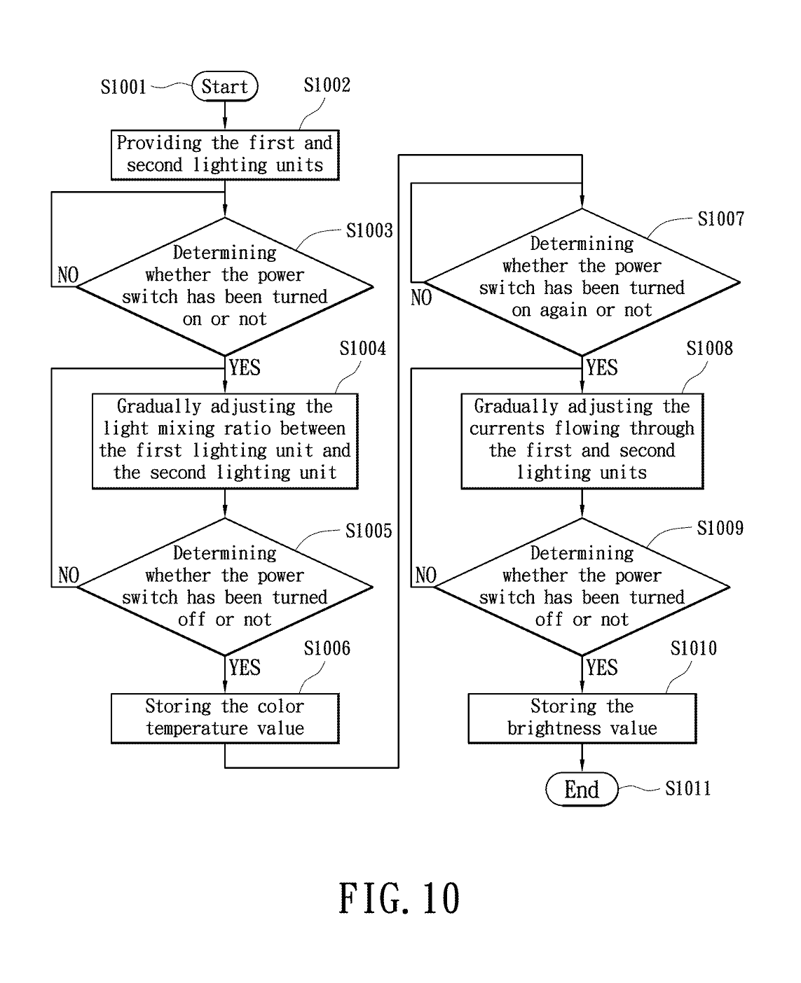

To provide those skilled in the art over the whole aspect of the techniques, the aforementioned embodiments may be generalized into a dimming method for the LED lighting apparatus. FIG. 10 shows a flow chart of the dimming method for the LED lighting apparatus of the sixth exemplary embodiment of the present invention. Please refer to FIG. 10, based on the aforementioned embodiments, the LED lighting apparatus is known to be coupled to power source through a power switch. The dimming method includes the following steps:

Step S1001: Start.

Step S1002: Providing a first lighting unit and a second lighting unit.

Step S1003: Determining whether or not the power switch has been turned on. If the power switch has not turned on, executes step S1003. When the power switch is turned on, executes step S1004.

Step S1004: Gradually adjusting the light mixing ratio between the first lighting unit and the second lighting unit according to the turn-on duration of the power switch.

Step S1005: Determining whether or not the power switch has been turned off. If the power switch has not been turned off, executes step S1004. When the power switch has been turned off within a predetermined time interval, executes step S1006.

Step S1006: Storing a color temperature value, accordingly.

Thus, when the power switch is turned on next time, the LED lighting apparatus may adjust the light mixing ratio between the first lighting unit and the second lighting unit according to the color temperature value and may generate the corresponding color temperature.

Step S1007: After storing the color temperature value, re-detecting whether or not the power switch has been turned on again. If the power switch has not been turned on, executes step S1007. When the power switch is turned on, executes step S1008.

Step S1008: Gradually adjusting the currents flowing through the first lighting unit and the second lighting unit according to the turn-on duration of the power switch.

Step S1009: Determining whether or not the power switch has been turned off within a predetermined time interval. If the power switch has been turned off, executes step S1008. When the power switch is turned off, executes step S1010.

Step S1010: Storing a brightness value, accordingly.

Thus, when the power switch is turned on next time, the first lighting unit and the second lighting unit may be driven according to the stored color temperature value and the brightness value to have the LED lighting apparatus generate the corresponding color temperature and brightness.

Step S1011: End.

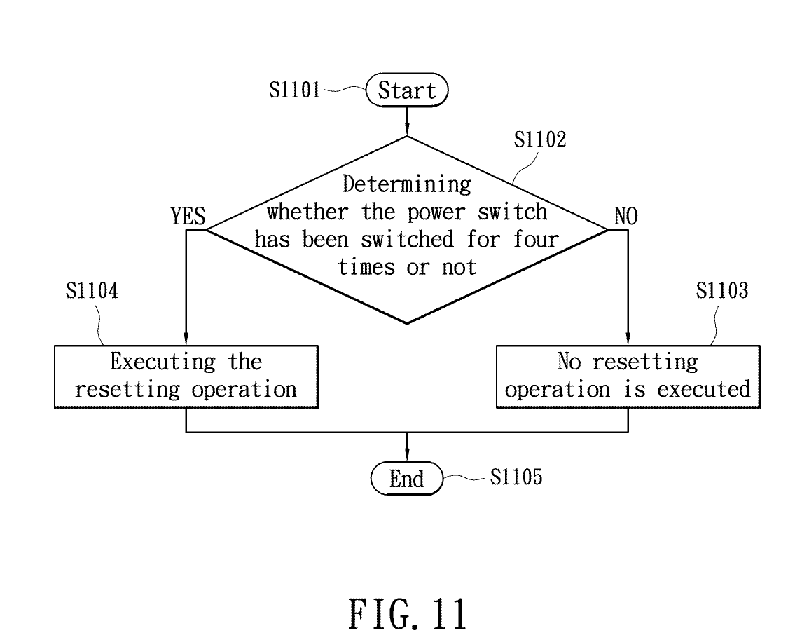

FIG. 11 shows a flow chart of resetting steps associated with the dimming method for the LED lighting apparatus according to the sixth exemplary embodiment of the present invention. Please refer to FIG. 11, the resetting steps include:

Step S1101: Start.

Step S1102: Determining whether or not the power switch has been switched for four times within a reset time interval. If not, executes step S1103, otherwise executes step S1104.

Step S1103: No resetting operation is executed.

Step S1104: Executing the resetting operation. The color temperature value and the brightness value stored in the storage unit are erased.

Step S1105: End.

On the basis of the above, the spirit of the present invention is to increase controlling operations by modifying the driving circuitries inside the LED lighting apparatus while accommodate the conventional switches enabling the user to adjust and configure the associated color temperature and brightness. The user does not have to install an extra dimming circuit, and thus no modification is need to the house for the installment of the dimming circuit.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. A light emitting diode (LED) lighting apparatus, coupled to a power source through a power switch, the LED lighting apparatus comprising:
a first lighting unit, having at least one first LED;
a second lighting unit, having at least one second LED;
a driving unit, coupled to the first lighting unit and the second lighting unit, for driving the first lighting unit and the second lighting unit; and
a detection unit, coupled to the driving unit and the power switch, for detecting a status of the power switch;
wherein when the power switch is turned on, the detection unit gradually adjusts a lighting mixing ratio between the first lighting unit and the second lighting unit according to a turn-on duration of the power switch, and stores a color temperature value accordingly.

2. The LED lighting apparatus according to claim 1, wherein when the power switch is turned off within a predetermined time interval after being turned on, the detection unit stores the color temperature value, and when the power switch is turned on next time, the detection unit adjusts the light mixing ratio between the first lighting unit and the second lighting unit according to the color temperature value to have the LED lighting apparatus generate corresponding color temperature.

3. The LED lighting apparatus according to claim 1, wherein the detection unit adjusts the light mixing ratio between the first lighting unit and the second lighting unit by respectively configuring a duty cycle of a first pulse width modulation signal corresponding to the first lighting unit and a duty cycle of a second pulse width modulation signal corresponding to the second lighting unit.

4. The LED lighting apparatus according to claim 1, wherein after the detection unit stores the color temperature, the detection unit then redetects whether or not the power switch is turned on again, gradually adjusting the currents flowing through the first lighting unit and the second lighting unit according to the turn-on duration of the power switch, and stores a brightness value, accordingly.

5. The LED lighting apparatus according to claim 4, wherein when the detection unit detects that the power switch being switched for four times within a reset time interval, the detection unit erases the stored color temperature value and the brightness value.

6. The LED lighting apparatus according to claim 1, wherein the detection unit comprises:
a voltage reduction circuit, coupled to the power source through the power switch; and
a control unit, coupled to the voltage reduction circuit and the driving unit, for counting the time that the power switch is turned on according to an output voltage of the voltage reduction circuit, and for outputting a color temperature control signal to the driving unit according to the color temperature value.

7. The LED lighting apparatus according to claim 6, wherein the control unit comprises:
a pulse circuit, coupled to the voltage reduction circuit, for generating a pulse signal correspondingly according to a change in the output voltage of the voltage reduction circuit;
a clock counting unit, coupled to the pulse circuit, for counting the time that the power switch is turned on according to the pulse signal outputted by the pulse circuit; and
a pulse width control unit, coupled to the clock counting unit, for outputting the color temperature control signal to the driving unit according to the turn-on duration of the power switch.

8. The LED lighting apparatus according to claim 1, wherein the detection unit further comprises a storage unit for storing the color temperature value.

9. The LED lighting apparatus according to claim 1, wherein the first LED is a cold white LED and the second LED is a warm white LED.

10. The LED lighting apparatus according to claim 3, wherein the second pulse width modulation signal has a direct current (DC) offset voltage.

11. A light emitting diode (LED) lighting apparatus coupled to a power source through a power switch, the LED lighting apparatus comprising:
a lighting unit, having at least one LED;
a driving unit, coupled to the lighting unit, for driving the lighting unit; and
a detection unit, coupled to the driving unit and the power switch, for detecting a status of the power switch;
wherein when the power switch is turned on, the detection unit gradually adjusts a current flowing through the lighting unit according to a turn-on duration of the power switch, and stores a brightness value, accordingly.

12. The LED lighting apparatus according to claim 11, wherein if the power switch is turned off within a predetermined time interval after being turned on, the detection unit stores the brightness value, and when the power switch is turned on again, the detection unit adjusts the current flowing through the lighting unit according to the brightness value to have the LED lighting apparatus generate corresponding brightness.

13. The LED lighting apparatus according to claim 11, wherein when the detection unit detects that the power switch being switched for four times within a reset time interval, the detection unit erases the stored brightness value.

14. A dimming method for a light emitting diode (LED) lighting apparatus being coupled to a power source through a power switch, the diming method comprising:
providing a first lighting unit and a second lighting unit;
detecting whether or not the power switch has being turned on; and
when the power switch has being turned on, gradually adjusting a lighting mixing ratio between the first lighting unit and the second lighting unit according to a turn-on duration of the power switch, and storing a color temperature value, accordingly.

15. The dimming method of the LED lighting apparatus according to claim 14, further comprising:
when the power switch is turned on again instantly after being turned off, adjusting the light mixing ratio between the first lighting unit and the second lighting unit according to the color temperature value to have the LED lighting apparatus generated corresponding color temperature.

16. The dimming method of the LED lighting apparatus according to claim 14, further comprising:
after storing the color temperature, detecting whether or not the power switch has being turned on, and gradually adjusting currents flowing through the first lighting unit and the second lighting unit according to the turn on duration of the power switch and storing a brightness value, accordingly.

17. The dimming method of the LED lighting apparatus according to claim 16, further comprising:
driving the first lighting unit and the second lighting unit according to the color temperature value and the brightness value stored to have the LED lighting apparatus generate corresponding color temperature and brightness.

18. The dimming method of the LED lighting apparatus according to claim 17, further comprising:
when the power switch has been switched for four times within a reset time interval, erasing the color temperature value and the brightness value stored.

19. The dimming method of the LED lighting apparatus according to claim 14, wherein the first lighting unit comprises of a cold white LED, and the second lighting unit comprises of a warm white LED.
